(19) United States
(12) Patent Application Publication
(10) Pub. No.: US 2015/0178502 A1
(43) Pub. Date: Jun. 25, 2015

(54) METHOD OF CONTROLLING MESSAGE OF ELECTRONIC DEVICE AND ELECTRONIC DEVICE THEREOF

(71) Applicant: Samsung Electronics Co., Ltd., Gyeonggi-do (KR)

(72) Inventor: Sang-Min Shin, Gyeonggi-do (KR)

(21) Appl. No.: 14/572,616

(22) Filed: Dec. 16, 2014

(30) Foreign Application Priority Data
Dec. 24, 2013 (KR) 10-2013-0162147

(51) Int. Cl. G06F 21/60; H04L 12/58

(52) U.S. Cl. CPC G06F 21/60; H04L 51/063

(57) ABSTRACT

A method of controlling a message of an electronic device includes receiving a screen capture request while displaying a messenger screen, selecting a security message from a plurality of messages displayed on the messenger screen, and editing out the security message and storing the security message into an image file. a display configured to display a messenger screen, a memory configured to store an image file, and a processor configured to, upon a request for capturing a screen, capture the messenger screen, select a security message from a plurality of messages displayed on the messenger screen, edit out the security message on the messenger screen, and store the security message in the image file.

### CROSS-REFERENCE TO RELATED APPLICATION

The present application is related to and claims the benefit under 35 U.S.C. §119(a) of a Korean patent application filed on Dec. 24, 2013 in the Korean Intellectual Property Office and assigned Serial Number 10-2013-0162147, the entire disclosure of which is hereby incorporated by reference.

### TECHNICAL FIELD

The present disclosure relates to a method of controlling a message of an electronic device and an electronic device thereof.

### BACKGROUND

Various types of electronic devices such as a smart phone or a tablet Personal Computer (PC) can execute a messenger program, which is software that can transmit and receive a message and data in real time through Internet. The messenger program may be referred to as an instant messenger in a meaning of immediately transmitting, and because a response is immediately performed, the messenger program can transmit and receive a message and data faster than an e-mail.

The messenger program supports 1:1 chatting, group chatting, and voice chatting and can transmit and receive a large volume of moving picture file. Further, because various services such as providing of news, stock, and music information are provided for free, most users using an electronic device such as a smart phone or a tablet PC widely use the messenger program.

However, because a message and data transmitted and received through the messenger program are weak in security, important personal information such as a bank account password or an Internet site password may be exposed without protection to another party.

### SUMMARY

To address the above-discussed deficiencies, it is a primary object to provide a method of controlling a message of an electronic device and an electronic device thereof that delete or change a security message displayed within a messenger screen and that store the security message into an image file, when screen capturing the messenger screen in the electronic device such as a smart phone or a tablet PC.

Another aspect of the present disclosure is to provide a method of controlling a message of an electronic device and an electronic device thereof for providing a user interface that enables a user to easily set a security message or that enables a user to cancel an already transmitted message, when transmitting and receiving a message using a messenger program in the electronic device such as a smart phone or a tablet PC.

In accordance with an aspect of the present disclosure, a method of operating an electronic device includes receiving a screen capture request while displaying a messenger screen, selecting a security message from a plurality of messages displayed on the messenger screen, and editing out the security message and storing the security message into an image file.

In accordance with another aspect of the present disclosure, an electronic device includes a display module that displays a messenger screen, a memory that stores an image file, and a processor that screen captures the messenger screen and that stores the messenger screen into an image file at the memory, wherein the processor selects a security message from a plurality of messages displayed on the messenger screen, edits out the security message, and stores the security message into an image file, when screen capture is requested.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a configuration of an electronic device according to various exemplary embodiments of the present disclosure;

FIG. 2 is a block diagram illustrating a configuration of hardware according to various exemplary embodiments of the present disclosure;

FIG. 3 is a block diagram illustrating a configuration of a programming module according to various exemplary embodiments of the present disclosure;

FIGS. 4A and 4B illustrate a process of storing a messenger screen into an image file;

FIGS. 5A and 5B illustrate a process of storing a messenger screen in which a security message is changed into an imaged file according to various exemplary embodiments of the present disclosure;

FIGS. 6A and 6B are diagrams illustrating a process of storing a messenger screen in which a security message is deleted into an imaged file according to various exemplary embodiments of the present disclosure;

FIG. 7 is a flowchart illustrating operation of a method of controlling a message of an electronic device according to various exemplary embodiments of the present disclosure;

FIG. 8 is a diagram illustrating a message management information database according to various exemplary embodiments of the present disclosure;

FIGS. 9A and 9B are diagrams illustrating a process of inputting a security message according to various exemplary embodiments of the present disclosure;

FIG. 10 is a flowchart illustrating operation of a method of controlling a message of an electronic device according to various exemplary embodiments of the present disclosure;

FIGS. 11A to 11C are diagrams illustrating a process of storing a messenger screen in which a security message is deleted into an image file according to various exemplary embodiments of the present disclosure;

FIG. 12 is a flowchart illustrating operation of a method of controlling a message of an electronic device according to various exemplary embodiments of the present disclosure;

FIGS. 13A to 13C are diagrams illustrating a process of storing a messenger screen in which a security message is deleted into an image file according to various exemplary embodiments of the present disclosure;

FIGS. 14A and 14B are diagrams illustrating a process of inputting a security message according to various exemplary embodiments of the present disclosure; and

FIGS. 15A and 15B are diagrams illustrating a process of cancelling an already transmitted message according to various exemplary embodiments of the present disclosure.

### DETAILED DESCRIPTION

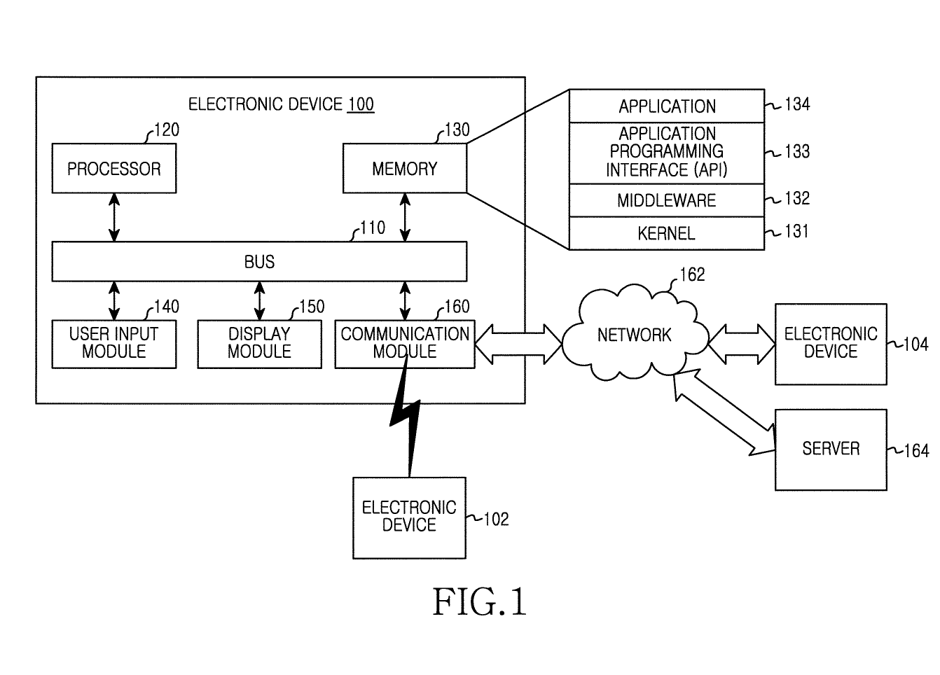

FIGS. 1 through 15B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Hereinafter, various exemplary embodiments of the present disclosure will be described with reference to the accompanying drawings. While the present disclosure may be embodied in many different forms, specific embodiments of the present disclosure are shown in drawings and are described herein in detail, with the understanding that the present disclosure is to be considered as an exemplification of the principles of the disclosure and is not intended to limit the disclosure to the specific embodiments illustrated. The same reference numbers are used throughout the drawings to refer to the same or like parts.

An electronic device according to various exemplary embodiments of the present disclosure can be a device including a communication function. The electronic device can be, for example, at least one combination of various devices such as a smart phone, a tablet Personal Computer (PC), a mobile phone, a video phone, an e-book reader, a desktop PC, a laptop PC, a Netbook computer, a Personal Digital Assistant (PDA), a Portable Multi-media Player (PMP), a Moving Picture Experts Group layer-3 (MP3) player, a mobile medical device, an electronic bracelet, an electronic necklace, electronic accessory, a camera, a wearable device, an electronic clock, a wrist watch, a smart white appliance (e.g., a refrigerator, an air-conditioner, a vacuum cleaner, an artificial intelligence robot, a television, a Digital Video Disk (DVD) player, an audio device, an oven, a microwave oven, a washing machine, an air cleaner, and an electronic frame), various medical devices (e.g., a Magnetic Resonance Angiography (MRA) device, a Magnetic Resonance Imaging (MRI) device, a Computed Tomography (CT) device, a scanning machine, and an ultrasonic wave device), a navigation device, a Global Positioning System (GPS) receiver, an Event Data Recorder (EDR), a Flight Data recorder (FDR), a set-top box, a television box (e.g., Samsung HomeSync™, Apple TV™, or Google TV™), an electronic dictionary, a vehicle infotainment device, an electronic equipment for ship (e.g., a navigation device for ship and gyro compass), avionics, a security device, electronic clothing, an electronic key, a camcorder, game consoles, a Head-Mounted Display (HMD), a flat panel display device, an electronic album, a portion of furniture or a building/structure including a communication function, an electronic board, an electronic signature receiving device, or a projector. An electronic device according to various exemplary embodiments of the present disclosure is not limited to the foregoing devices.

FIG. 1 is a block diagram illustrating a configuration of an electronic device according to an exemplary embodiment of the present disclosure.

Referring to FIG. 1, an electronic device 100 can include a bus 110, a processor 120, a memory 130, a user input unit 140, a display unit 150, and a communication unit 160. The bus 110 can be a circuit that connects the foregoing constituent elements and that performs communication (e.g., transmit a control message) between the foregoing constituent elements.

The processor 120 can receive an instruction from the foregoing other elements (e.g., the memory 130, the user input module 140, the display module 150, and the communication module 160) through, for example, the bus 110, decode the received instruction, and execute operation or a data processing according to the decoded instruction. The memory 130 can store an instruction or data received from the processor 120 or other elements (e.g., the user input module 140, the display module 150, and the communication module 160) or generated by the processor 120 or other elements.

The memory 130 can include a programming module such as a kernel 131, middleware 132, an Application Programming Interface (API) 133, or an application 134. The foregoing respective programming modules can be formed with software, firmware, hardware, or a combination of at least two thereof.

The kernel 131 can control or manage a system resource (e.g., the bus 110, the processor 120, or the memory 130) used for executing an operation or a function implemented in the remaining programming modules, for example, the middleware 132, the API 133, or the application 134. Further, the kernel 131 can provide an interface that can access to an individual constituent element of the electronic device 100 in the middleware 132, the API 133, or the application 134 to control or manage the individual constituent element.

The middleware 132 can perform an intermediary function of enabling the API 133 or the application 134 to communicate with the kernel 131 to give and receive data. Further, the middleware 132 can perform load balancing of work requests received from the (plurality of) applications 134 using a method of aligning a priority that can use a system resource (e.g., the bus 110, the processor 120, or the memory 130) of the electronic device 100 in, for example, at least one application of the (plurality of) applications 134.

The API 133 is an interface that enables the application 134 to control a function in which the kernel 131 or the middleware 132 provides and can include, for example, at least one interface or function for file control, window control, image processing, or text control.

The user input module 140 can receive, for example, an input of an instruction or data from a user and transfer the instruction or data to the processor 120 or the memory 130 through the bus 110, and the display module 150 can display a picture, an image, or data to the user.

The communication unit 160 can connect communication between another electronic device 102 and the electronic device 100 and support a predetermined short range communication protocol (e.g., Wireless Fidelity (WiFi), Bluetooth (BT), Near Field Communication (NFC)), or communication of a predetermined network (e.g., Internet, a Local Area Network (LAN), a Wide Area Network (WAN), a telecommunication network, a cellular network, a satellite network, or a Plain Old Telephone Service (POTS)) 162. The electronic devices 102 and 104 each can be the same device (e.g. the same type) as the electronic device 100 or can be devices different (e.g., different type) from the electronic device 100.

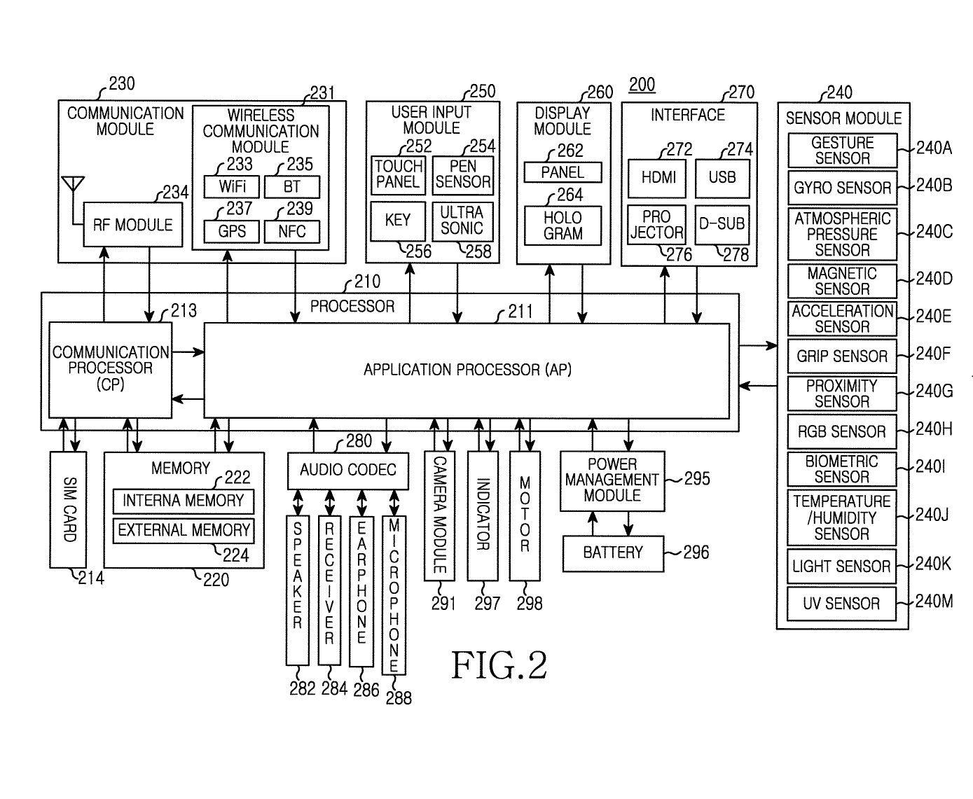

FIG. 2 is a block diagram illustrating a configuration of hardware according to an exemplary embodiment of the present disclosure. Hardware 200 can be, for example, the electronic device 100 of FIG. 1.

Referring to FIG. 2, the hardware 200 can include at least one processor 210, a Subscriber Identification Module (SIM) card 214, a memory 220, a communication module 230, a sensor module 240, a user input module 250, a display module 260, an interface 270, an audio codec 280, a camera module 291, a power management module 295, a battery 296, an indicator 297, or a motor 298.

The processor 210 (e.g., the processor 120) can include at least one Application Processor (AP) 211 or at least one Communication Processor (CP) 213. The processor 210 can be, for example, the processor 120 of FIG. 1. FIG. 2 illustrates that the AP 211 and the CP 213 are included within the processor 210, but the AP 211 and the CP 213 can be included within different IC packages, respectively. In an exemplary embodiment, the AP 211 and the CP 213 can be included within an IC package.

The AP 211 can drive an operation system or an application program to control a plurality of hardware or software components connected to the AP 211 and perform various data processing and operations including multimedia data. The AP 211 can be implemented with, for example, a System on Chip (SoC). According to an exemplary embodiment, the processor 210 can further include a Graphic Processing Unit (GPU) (not shown). The CP 213 can perform a function of managing a data link or converting a communication protocol in communication between other electronic devices connected to an electronic device (e.g., the electronic device 100) including the hardware 200 by a network. The CP 213 can be implemented with, for example, an SoC.

According to an exemplary embodiment, the CP 213 can perform at least a portion of a multimedia control function. The CP 213 can perform identification and authentication of a terminal within a communication network using, for example, a subscriber identification module (e.g., the SIM card 214). Further, the CP 213 can provide services such as audio dedicated communication, audiovisual communication, a text message, or packet data to the user. Further, the CP 213 can control data transmission and reception of the communication module 230. In FIG. 2, elements of the CP 213, the power management module 295, or the memory 220 are elements separate from the AP 211, but according to an exemplary embodiment, the AP 211 can include at least a portion (e.g., the CP 213) of the foregoing elements.

According to an exemplary embodiment, the AP 211 or the CP 213 can load and process an instruction or data received from at least one of other elements or a non-volatile memory connected to each of the AP 211 and the CP 213 in a volatile memory. Further, the AP 211 or the CP 213 can store data received from at least one of other elements or generated by at least one of other elements at a non-volatile memory. The SIM card 214 can be a card that implements a subscriber identity module and be inserted into a slot formed at a specific location of the electronic device. The SIM card 214 can include intrinsic identification information (e.g., Integrated Circuit Card Identifier (ICCID)) or subscriber information (e.g., International Mobile Subscriber Identity (IMSI)).

The memory 220 can include an internal memory 222 or an external memory 224. The memory 220 can be, for example, the memory 130 of FIG. 1. The internal memory 222 can include at least one of, for example, a volatile memory (e.g., Dynamic RAM (DRAM), Static RAM (SRAM), Synchronous Dynamic RAM (SDRAM)), or a non-volatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, NAND flash memory, and NOR flash memory).

According to an exemplary embodiment, the internal memory 222 can have a form of a Solid State Drive (SSD). The external memory 224 can further include a flash drive, for example, a Compact Flash (CF), Secure Digital (SD), Micro Secure Digital (Micro-SD), Mini Secure Digital (Mini-SD), extreme Digital (xD), or memory stick. The communication module 230 can include a wireless communication module 231 or a Radio Frequency (RF) module 234. The communication module 230 can be, for example, the communication module 160 of FIG. 1. The wireless communication module 231 can include, for example, a WiFi module 233, a Bluetooth (BT) module 235, a GPS module 237, or an NFC module 239. For example, the wireless communication module 231 can provide a wireless communication function using a radio frequency.

Additionally or alternatively, the wireless communication module 231 can include a modem or a network interface (e.g., a LAN card) that connects the hardware 200 to a network (e.g., Internet, a LAN, a WAN, a telecommunication network, a cellular network, a satellite network, or a POTS. The RF unit 234 can perform transmission and reception of data, for example, transmission and reception of an RF signal or a called electronic signal. Although not shown, the RF module 234 can include, for example, a transceiver, a Power Amp Module (PAM), a frequency filter, or a Low Noise Amplifier (LNA).

Further, the RF module 234 can further include a component, for example, a conductor or a conductive wire that transmits and receives electromagnetic waves on free space in wireless communication. The sensor module 240 can include at least one of, for example, a gesture sensor 240A, a gyro sensor 240B, an atmospheric pressure sensor 240C, a magnetic sensor 240D, an acceleration sensor 240E, a grip sensor 240F, a proximity sensor 240G, a Red, Green, and Blue (RGB) sensor 240H, a bio sensor 240I, a temperature/humidity sensor 240J, an illumination sensor 240K, or a Ultra Violet (UV) sensor 240M. The sensor module 240 can measure a physical quantity or detect an operation state of the electronic device and convert measured or detected information to an electric signal.

Additionally or alternatively, the sensor module 240 can include, for example, an E-nose sensor (not shown), an electromyography sensor (EMG sensor) (not shown), an electroencephalogram sensor (EEG sensor) (not shown), an electrocardiogram sensor (ECG sensor) (not shown), or a fingerprint sensor (not shown). The sensor module 240 can further include a control circuit that controls at least one sensor belonging to the inside thereof. The user input module 250 can include a touch panel 252, a (digital) pen sensor 254, a key 256, or an ultrasonic wave input device 258. The user input module 250 can be, for example, the user input module 140 of FIG. 1. The touch panel 252 can recognize a touch input with at least one method of, for example, a capacitive, resistive, infrared ray, or ultrasonic wave method.

Further, the touch panel 252 can further include a controller (not shown). A capacitive touch panel can perform proximity recognition as well as a direct touch. The touch panel 252 can further include a tactile layer. In this case, the touch panel 252 can provide a haptic reaction to the user. The (digital) pen sensor 254 can be implemented using the same method as and a method similar to, for example, reception of a touch input of the user or a separate recognition sheet. As the key 256, for example, a keypad or a touch key can be used.

The ultrasonic wave input device 258 can determine data by detecting a sound wave with a microphone (e.g., a microphone 288) in a terminal through a pen that generates an ultrasonic wave signal and perform wireless recognition. According to an exemplary embodiment, the hardware 200 can receive a user input from an external device (e.g., a network, computer, or server) connected to the communication module 230 using the communication module 230. The display module 260 can include a panel 262 or a hologram 264. The display module 260 can be, for example, the display module 150 of FIG. 1. The panel 262 can be, for example, a Liquid Crystal Display (LCD) or an Active-Matrix Organic Light-Emitting Diode (AMOLED). The panel 262 can be implemented with, for example, a flexible, transparent, or wearable method.

The panel 262 and the touch panel 252 can be formed in a module. The hologram 264 can show a stereoscopic image in the air using interference of light. According to an exemplary embodiment, the display module 260 can further include a control circuit for controlling a panel 262 or a hologram 264. The interface 270 can include, for example, a High-Definition Multimedia Interface (HDMI) 272, a Universal Serial Bus (USB) 274, a projector 276, or a D-subminiature (D-sub) 278. Additionally or alternatively, the interface 270 can include, for example, Secure Digital (SD)/Multi-Media Card (MMC)(not shown), or Infrared Data Association (IrDA) (not shown).

The audio codec 280 can interactively convert audio and an electric signal. For example, the audio codec 280 can convert audio information input or output through a speaker 282, a receiver 284, an earphone 286, or a microphone 288. The camera module 291 can photograph an image and a moving picture, and according to an exemplary embodiment, the camera module 291 can include at least one image sensor (e.g., a front surface lens or a rear surface lens), an Image Signal Processor (ISP) (not shown), or a flash LED (not shown).

The power management module 295 can manage power of the hardware 200. Although not shown, the power management module 295 can include, for example, a Power Management Integrated Circuit (PMIC), a charger Integrated Circuit (charge IC), or a battery fuel gauge. The PMIC can be mounted within, for example, an IC or an SoC semiconductor. A charging method can be classified into a wired method and a wireless method. The charge IC can charge a battery and prevent an overvoltage or an overcurrent from being injected from a charger.

According to an exemplary embodiment, the charge IC can include a charge IC for at least one of a wired charge method and a wireless charge method. The wireless charge method can include, for example, a magnetic resonance method, a magnetic induction method, or an electromagnetic wave method and can add an additional circuit, for example, a circuit such as a coil loop, a resonant circuit, and a rectifier for wireless charge.

The battery gauge can measure, for example, a residual quantity of the battery 296, a voltage, a current, or a temperature while charging. The battery 296 can generate electricity to supply power and can be, for example, a rechargeable battery.

The indicator 297 can display a specific state, for example, a booting state, a message state, or a charge state of the hardware 200 or a portion (e.g., the AP 211) thereof. The motor 298 can convert an electrical signal to a mechanical vibration. An MCU (not shown) can control the sensor module 240. Although not shown, the hardware 200 can include a processing device (e.g., Graphics Processing Unit (GPU) for supporting a mobile TV. The processing device for supporting a mobile TV can process media data according to a specification such as Digital Multimedia Broadcasting (DMB), Digital Video Broadcasting (DVB), or media flow.

A name of the foregoing constituent elements of hardware according to various exemplary embodiments of the present disclosure can be changed according to a kind of an electronic device. The hardware according to various exemplary embodiments of the present disclosure can include at least one of the foregoing elements and can omit some elements or can further include additional other elements. Further, when some of elements of hardware according to various exemplary embodiments of the present disclosure are coupled to form an entity, the entity can equally perform a function of corresponding elements before coupling.

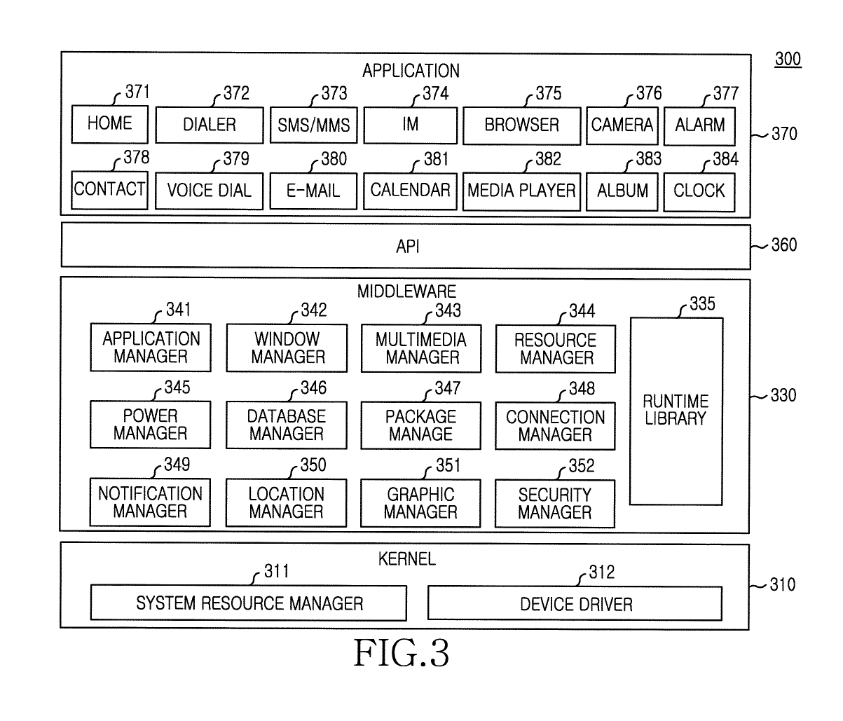

FIG. 3 is a block diagram illustrating a configuration of a programming module according to an exemplary embodiment of the present disclosure. A programming module 300 can be included (e.g., stored) in the electronic device 100 (e.g., the memory 130) of FIG. 1. At least a portion of the programming module 300 can be formed with software, firmware, hardware, or a combination of at least two thereof. The programming module 300 can include an Operation System (OS) implemented in the hardware 200 to control a resource related to an electronic device (e.g., the electronic device 100) or various applications (e.g., an application 370) driven on the OS.

For example, the OS can be Android, iOS, Windows, Symbian, Tizen, or Bada. Referring to FIG. 3, the programming module 300 can include a kernel 310, middleware 330, an Application Programming Interface (API) 360, or an application 370. The kernel 310 (e.g., kernel 131) can include a system resource manager 311 or a device driver 312.

The system resource manager 311 can perform the control, allocation, or recovery of a system resource. Further, according to an exemplary embodiment, the device driver 312 can include an Inter-Process (IPC) Communication (not shown) driver.

In order to provide a function in which the application 370 commonly requires, the middleware 330 can include a previously implemented plurality of modules. Further, the middleware 330 can provide a function through the API 360 so that the application 370 can efficiently use a limited system resource within the electronic device.

For example, as shown in FIG. 3, the middleware 330 (e.g., the middleware 132) can include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

In order to add a new function through a programming language while the application 370 is being executed, the run-time library 335 can include a library module in which a compiler uses. According to an exemplary embodiment, the run-time library 335 can perform a function of an input and output, memory management, or arithmetic function.

The application manager 341 can manage a life cycle of, for example, at least one of the applications 370. The window manage 342 can manage a GUI resource using on a screen. The multimedia manager 343 can grasp a format necessary for reproduction of various media files and encode or decode media files using a codec corresponding to the format. The resource manager 344 can manage a resource of a source code, a memory, or a stored space of at least one application of the applications 370.

The power manager 345 can manage a battery or power by operating together with a Basic Input/Output System (BIOS) and provide power information necessary for operation. The database manager 346 can manage to generate, search for, or change a database to use in at least one application of the applications 370.

The package manager 347 can manage installation or update of an application distributed in a format of a package file. The connectivity manager 348 can manage wireless connection of, for example, WiFi™ or Bluetooth™. The notification manager 349 can display or notify an event such as an arrival message, appointment, and proximity notification with a method that disturbs a user. The location manager 350 can manage location information of the electronic device 100.

The graphic manager 351 can manage a graphic effect to be provided to a user or a user interface related thereto. The security manager 352 can provide several security functions necessary for system security or user authentication. According to an exemplary embodiment, when the electronic device (e.g., the electronic device 100) has a phone function, the middleware 330 can further include a telephony manager (not shown) for managing an audio communication function or an audiovisual communication function of the electronic device.

The middleware 330 can generate and use a new middleware module through various function combinations of the foregoing internal constituent element modules. In order to provide a distinguished function, the middleware 330 can provide a specialized module on a kind basis of an OS. Further, the middleware 330 can dynamically partially delete an existing constituent element or add new constituent elements. Therefore, a constituent element described in an exemplary embodiment of the present disclosure can be partially omitted or another constituent element can be further included, or the constituent element can be replaced with a constituent element that has another name and that performs a similar function.

The API 360 (e.g. the API 133) is a set of API programming functions and can be provided in other configurations according to an OS. For example, in Android or IOS, one API set can be provided on a platform basis, and in Tizen™, at least two API set can be provided. The application 370 (e.g., the application 134) can include, for example, a preloaded application or a third party application.

At least a portion of the programming module 300 can be implemented with an instruction stored at computer-readable storage media. When the instruction is executed by at least one processor (e.g., the processor 120), the at least one processor can perform a function corresponding to the instruction. The computer readable storage media can be, for example, the memory 220. At least a portion of the programming module can be implemented (e.g., executed) by, for example, the processor 210.

At least a portion of the programming module 300 can include, for example, a module, a program, a routine, sets of instructions, or a process that performs at least one function. A name of constituent elements of a programming module (e.g., the programming module 300) according to various exemplary embodiments of the present disclosure can be changed according to a kind of an OS. Further, the programming module can include at least one of the foregoing constituent elements, can omit some constituent elements, or can further include additional other constituent elements.

Hereinafter, an operation principle according to various exemplary embodiments of present disclosure will be described in detail with reference to the accompanying drawings. Further, detailed descriptions of well-known functions and structures incorporated herein can be omitted to avoid obscuring the subject matter of the present disclosure. The terms used herein are defined in consideration of various exemplary embodiments of the present disclosure. Thus, the terms can vary depending on a user's or an operator's intension and usage. That is, the terms used herein should be understood based on the descriptions made herein.

Hereinafter, a method of controlling a message of an electronic device according to various exemplary embodiments of the present disclosure and an electronic device thereof will be described in detail. An electronic device according to various exemplary embodiments of the present disclosure can include constituent elements of FIG. 2. For example, various types of electronic devices such as a smart phone or a tablet PC can provide 1:1 chatting, group chatting, and voice chatting by executing a messenger program.

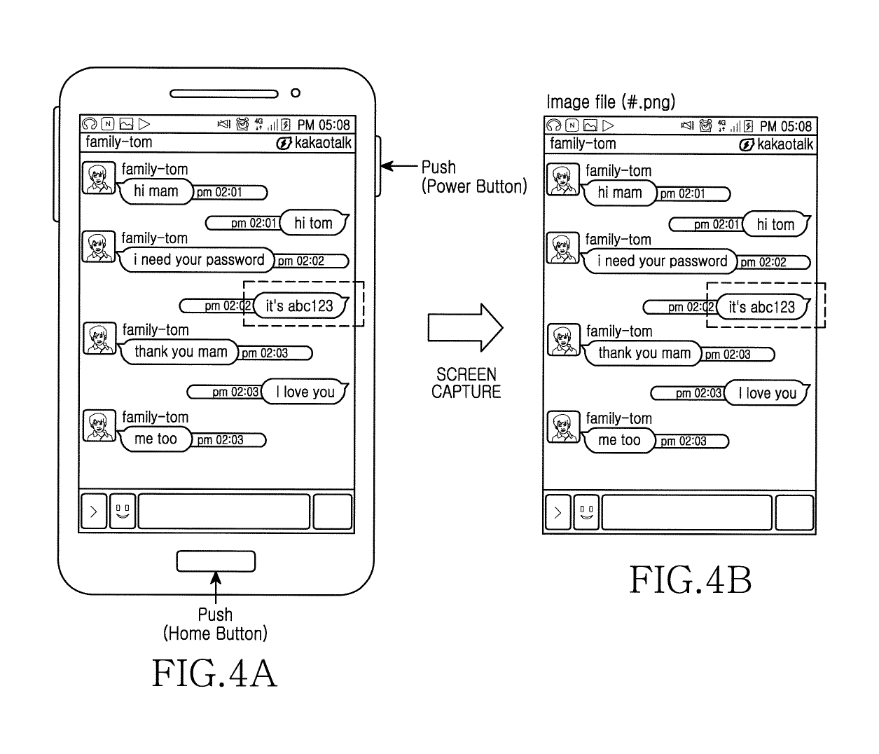

FIGS. 4A and 4B are diagrams illustrating a process of storing a messenger screen into an image file.

As shown in FIGS. 4A and 4B, in the display module 260 of the electronic device 200 such as a smart phone, a messenger screen can be displayed.

On the messenger screen, a plurality of messages transmitted and received through, for example, 1:1 online chatting can be sequentially displayed, and the plurality of messages can include important personal information such as a user password.

The processor 210 of the electronic device can capture a messenger screen in which the plurality of messages are displayed according to a user request and perform a screen capture operation that stores the captured messenger screen into an image file. For example, as shown in FIGS. 4A and 4B, when a power button and a home button are simultaneously pushed by a user, the processor 210 captures a messenger screen displayed in the display module 260 and stores the captured messenger screen into an image file within the memory 220.

The image file can be a Portable Network Graphic (PNG) file, which is a lossless graphic file, a GIF file, or a JPEG file. The image file includes an entire message displayed on the messenger screen. For example, important personal information such as a user password can be exposed to another party without protection through the image file.

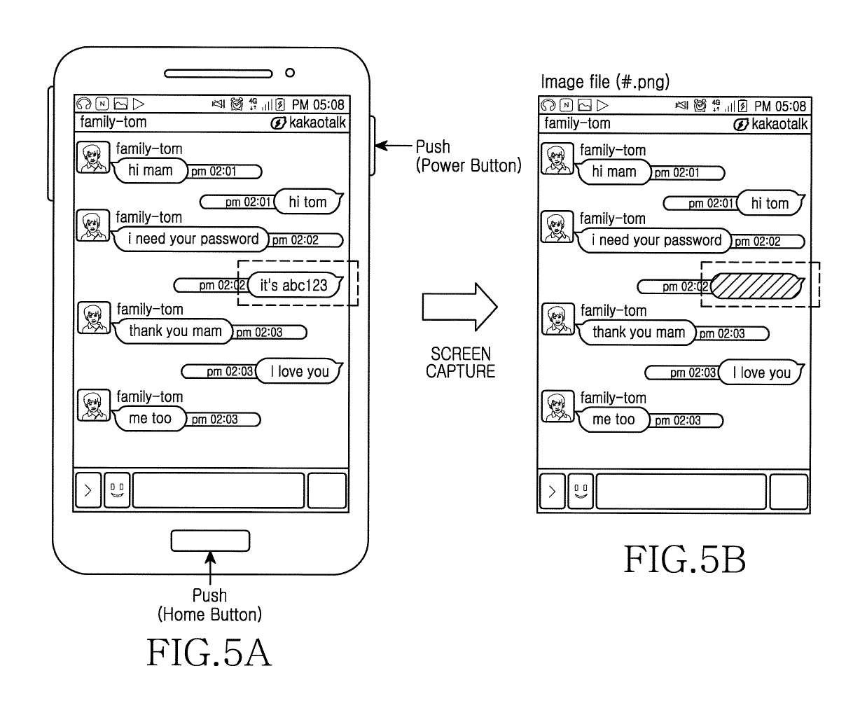

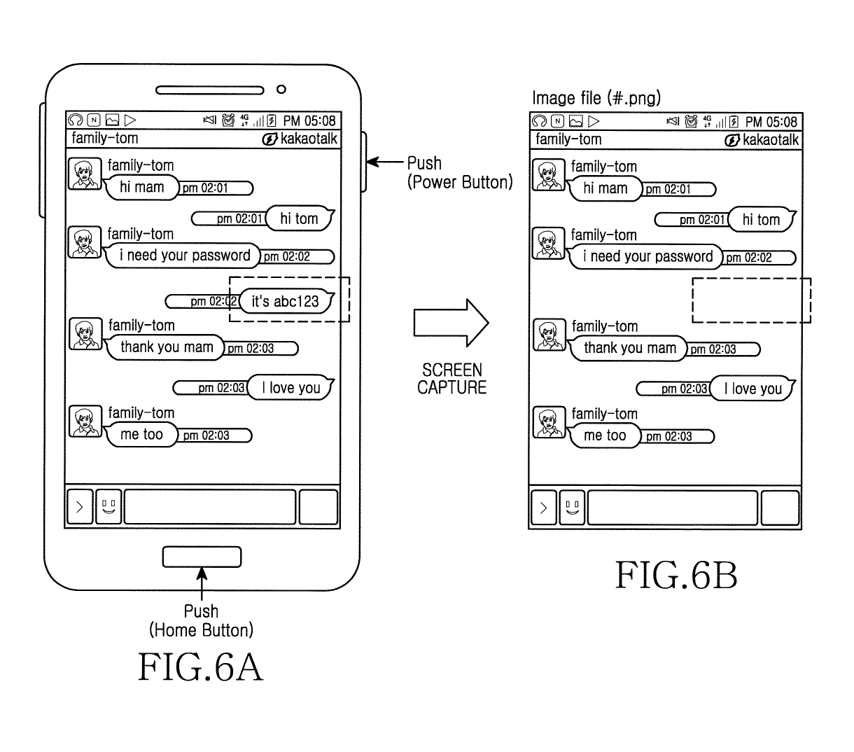

FIGS. 5A and 5B are a diagram illustrating a process of storing a messenger screen in which a security message is changed into an imaged file according to various exemplary embodiments of the present disclosure, and FIG. 6 is a diagram illustrating a process of storing a messenger screen in which a security message is deleted into an imaged file according to various exemplary embodiments of the present disclosure.

For example, the processor 210 of an electronic device such as a smart phone or a tablet PC according to various exemplary embodiments of the present disclosure can receive a screen capture request while displaying a messenger screen through the display module 260. The screen capture request can be received when a user simultaneously pushes a power button and a home button or when a user performs a preset random specific operation for a screen capture request.

When the screen capture request is received, the processor 210 performs an editing operation that changes or deletes a security message of a plurality of messages displayed on the messenger screen and stores the message into an image file in which contents of the security message are not displayed.

For example, as shown in FIG. 5, by variously changing and editing a speech bubble in which a security message is displayed with oblique lines or a black color, the processor 210 can enable contents of the security message such as personal information not to be displayed.

Further, as shown in FIGS. 6A and 6B, by entirely deleting a speech bubble and time information in which the security message is displayed, the processor 210 can enable contents of a security message such as personal information not to be displayed.

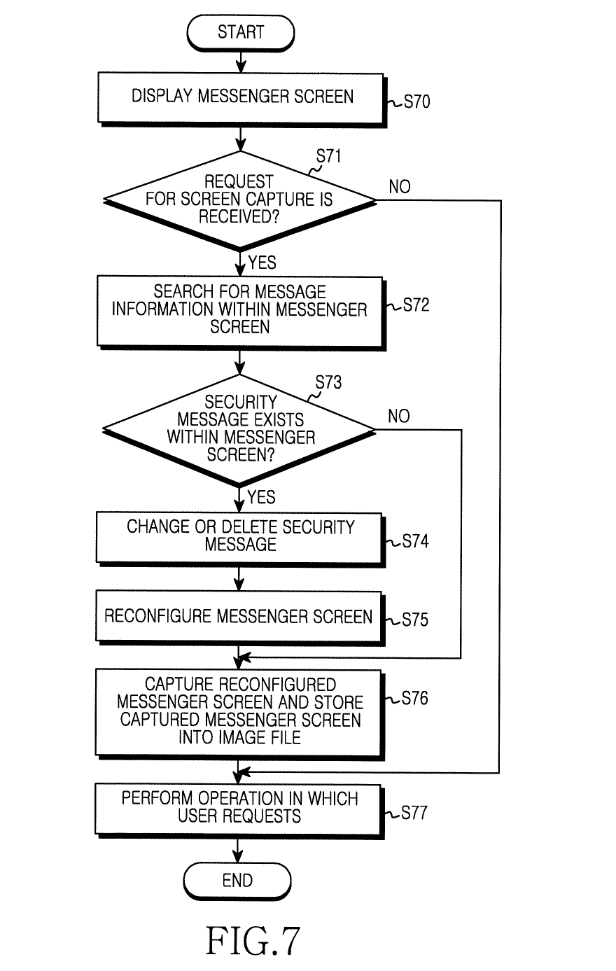

FIG. 7 is a flowchart illustrating operation of a method of controlling a message of an electronic device according to various exemplary embodiments of the present disclosure. For example, in the display module 260 of the electronic device 200 such as a smart phone or a tablet PC in which a messenger program is executed, a messenger screen can be displayed (S70).

On the messenger screen, a plurality of messages transmitted and received through 1:1 online chatting can be sequentially displayed, and the plurality of messages can include important personal information such as a user password. For example, when a user simultaneously pushes a power button and a home button or when a user performs a preset random specific operation for a screen capture request, the processor 210 of the electronic device receives a screen capture request corresponding thereto.

The processor 210 determines whether a request for screen capture is received (S71), and if a request for screen capture is received, the processor 210 searches for message information within the messenger screen (S72) and determines whether a security message exists within the messenger screen (S73). For example, the processor 210 can search for a message management information database stored within the memory 220 of the electronic device 200 or stored within a messenger server that provides a messenger service as management information about a plurality of messages displayed within the messenger screen.

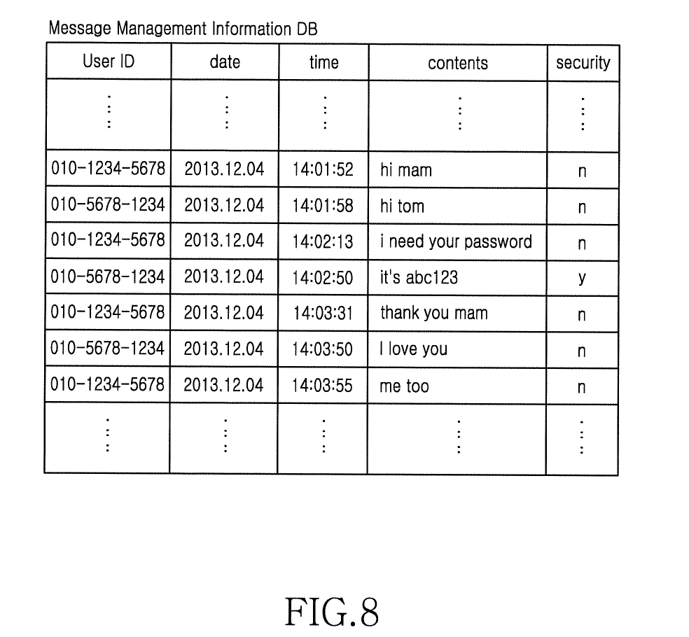

FIG. 8 is a diagram illustrating a message management information database according to various exemplary embodiments of the present disclosure. For example, as shown in FIG. 8, the message management information database can include user ID information that transmits and receives a message, transmitting and receiving date and time information, and message content information and can further include a security code for representing that a corresponding message is a security message. For example, when an electronic device such as a smart phone performs a screen capture operation, the security code is information for designating to change or delete a corresponding message not to be displayed and can be variously set to a random specific value.

Further, the message management information can variously additionally include a time limitation code for limiting a display time of a corresponding message and a number limitation code for limiting the display number of a corresponding message. The time limitation code can limit a display time of a corresponding message to a period of a determined time (e.g., a time period of 10 minutes) or can limit a display time of a corresponding message to a specific time (e.g., PM 9:30), and the number limitation code can limit the display number of a corresponding message to the predetermined number of times (e.g., three times).

The processor 210 searches for a security code included within the message management information database, and if a security message exists within the messenger screen at operation S73, the processor 210 performs an editing operation that changes or deletes the security message not to be displayed (S74).

The processor 210 reconfigures a messenger screen in which contents of the security message are not displayed (S75), screen captures the reconfigured messenger screen and stores the captured messenger screen into an image file (S76), and performs operation in which the user requests (S77).

The reconfigured messenger screen can be displayed through the display module 260 or may not be displayed so that a user does not know. Accordingly, as described with reference to FIGS. 5 and 6, because contents of a security message such as personal information are not included in an image file stored by a screen capture operation, the contents of the security message can be prevented from being exposed to another party.

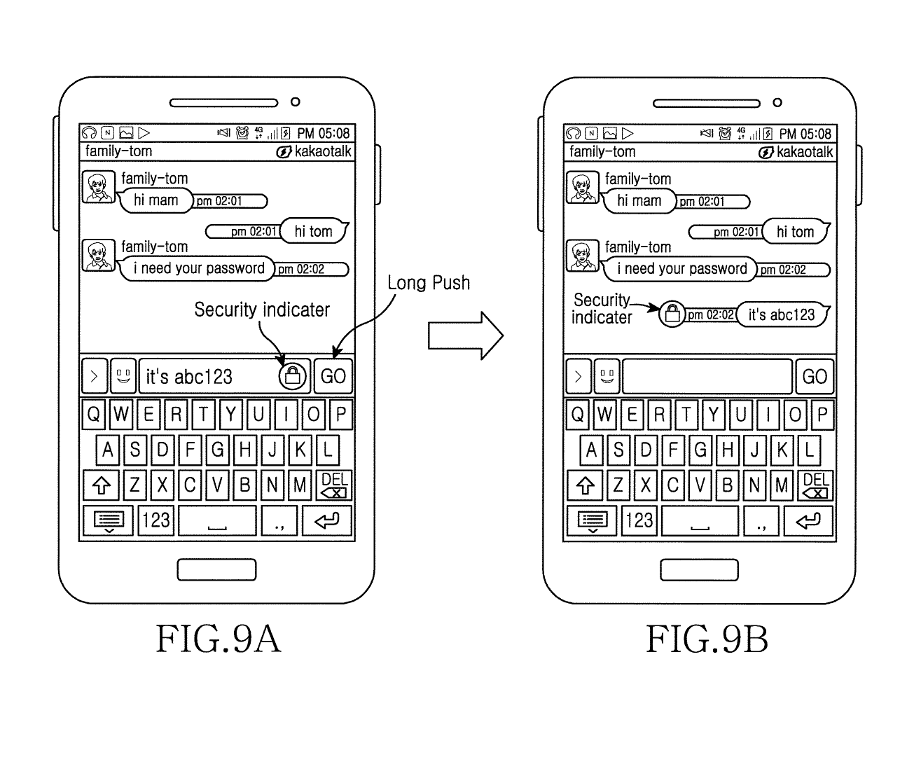

FIGS. 9A and 9B are diagrams illustrating a process of inputting a security message according to various exemplary embodiments of the present disclosure. For example, as shown in FIGS. 9A and 9B, before the user transmits a message written through the messenger screen, when the user long pushes a transmitting button (e.g., GO), the processor 210 can control to display a security indicator notifying setting of the security message. The security indicator can be variously displayed in at least one shape of, for example, a lock, a bomb, a hourglass, and a timer and can be randomly selected in a shape in which a user wants through various user interface screens provided through the display module 260.

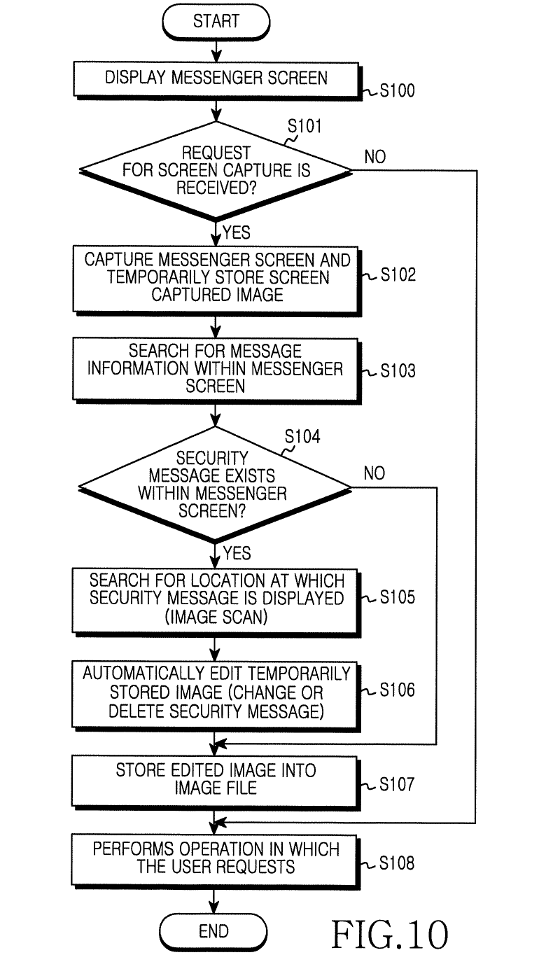

FIG. 10 is a flowchart illustrating operation of a method of controlling a message of an electronic device according to various exemplary embodiments of the present disclosure. For example, in the display module 260 of the electronic device 200 such as a smart phone or a tablet PC in which a messenger program is executed, a messenger screen can be displayed (S100).

On the messenger screen, a plurality of messages transmitted and received through 1:1 online chatting can be sequentially displayed, and the plurality of messages can include important personal information such as a user password. For example, when a user simultaneously pushes a power button and a home button or when a user performs a preset random specific operation for a screen capture request, the processor 210 of the electronic device receives a screen capture request corresponding thereto.

The processor 210 determines whether a request for screen capture is received (S101), and if a request for screen capture is received, the processor 210 screen captures the messenger screen and temporarily stores the screen captured image (S102).

The processor 210 searches for message information within the messenger screen (S103) and determines whether a security message exists within the messenger screen (S104). For example, as described with reference to FIG. 8, the processor 210 can search for a message management information database stored within the memory 220 of the electronic device 200 or stored within a messenger server that provides a messenger service, and if a security message exists within the messenger screen at operation S104, the processor 210 performs an image scan operation and searches for a location at which a security message is displayed within the temporarily stored image (S105).

The processor 210 performs an editing operation that automatically changes or deletes the temporarily stored image so that contents of the security message are not displayed (S106) and stores the edited image into an image file (S107) and performs operation in which the user requests (S108).

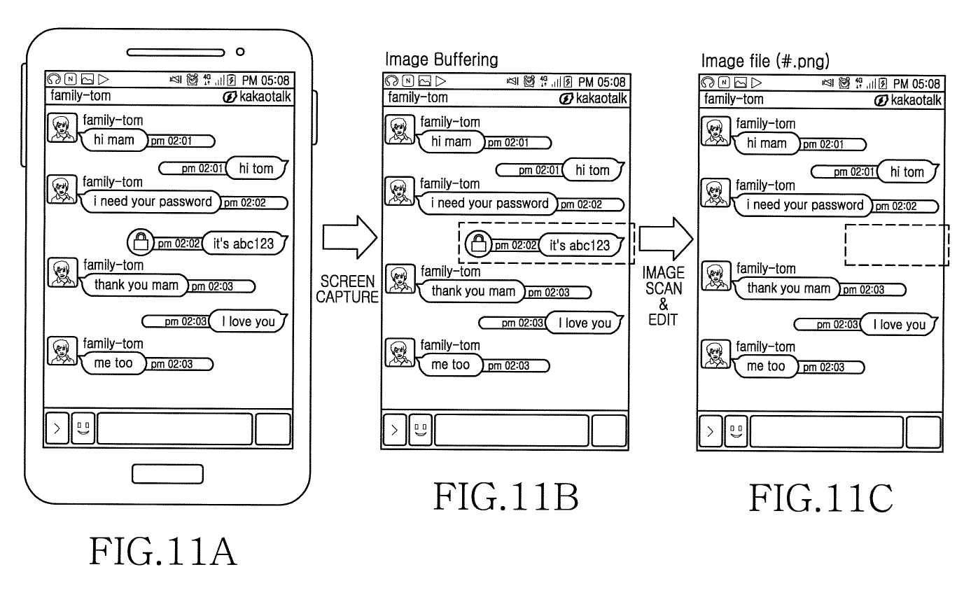

FIGS. 11A to 11C are diagrams illustrating a process of storing a messenger screen in which a security message is deleted into an image file according to various exemplary embodiments of the present disclosure. For example, as shown in FIGS. 11A to 11C, in the security message within the messenger screen, a security indicator of a specific color (e.g., blue) or a specific shape (e.g., lock) notifying setting of the security message can be together displayed.

The processor 210 can search for a display location of the security indicator through an image scan operation, determine a display location at which the security indicator is found to a display location of the security message, and perform various editing operations that delete or change predetermined pixel lines within an image. Accordingly, as described with reference to FIGS. 11A to 11C, because contents of a security message such as personal information are not included in an image file stored by a screen capture operation, the contents of the security message can be prevented from being exposed to another party.

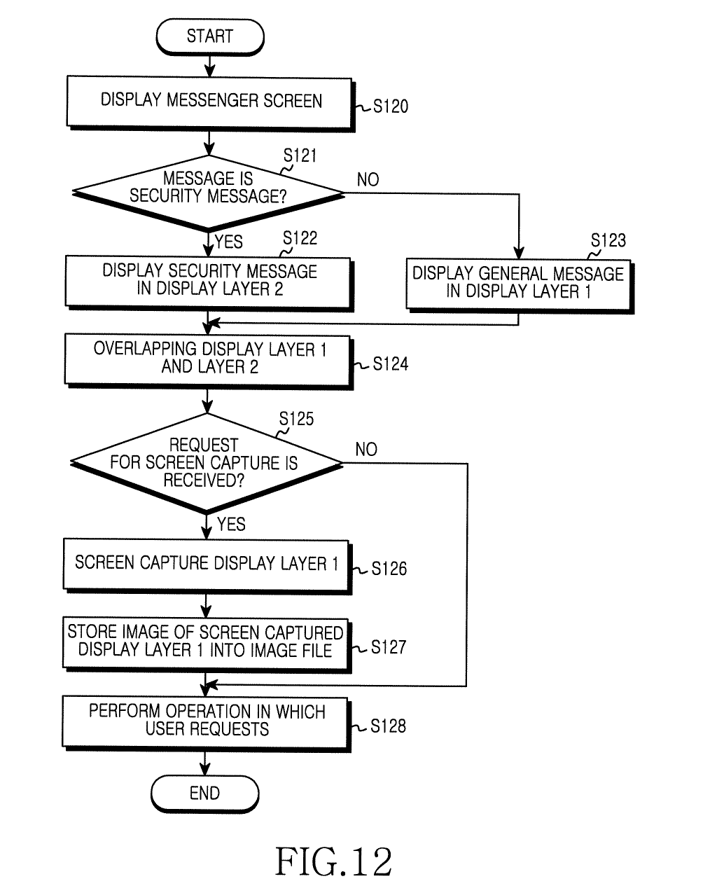

FIG. 12 is a flowchart illustrating operation of a method of controlling a message of an electronic device according to various exemplary embodiments of the present disclosure. For example, in the display module 260 of the electronic device 200 such as a smart phone or a tablet PC in which a messenger program is executed, a messenger screen can be displayed (S120).

On the messenger screen, a plurality of messages transmitted and received through 1:1 online chatting can be sequentially displayed, and the plurality of messages can include important personal information such as a user password.

The processor 210 of the electronic device determines whether a message transmitted and received through the 1:1 online chatting is a general message or a security message in which a security code is set (S121).

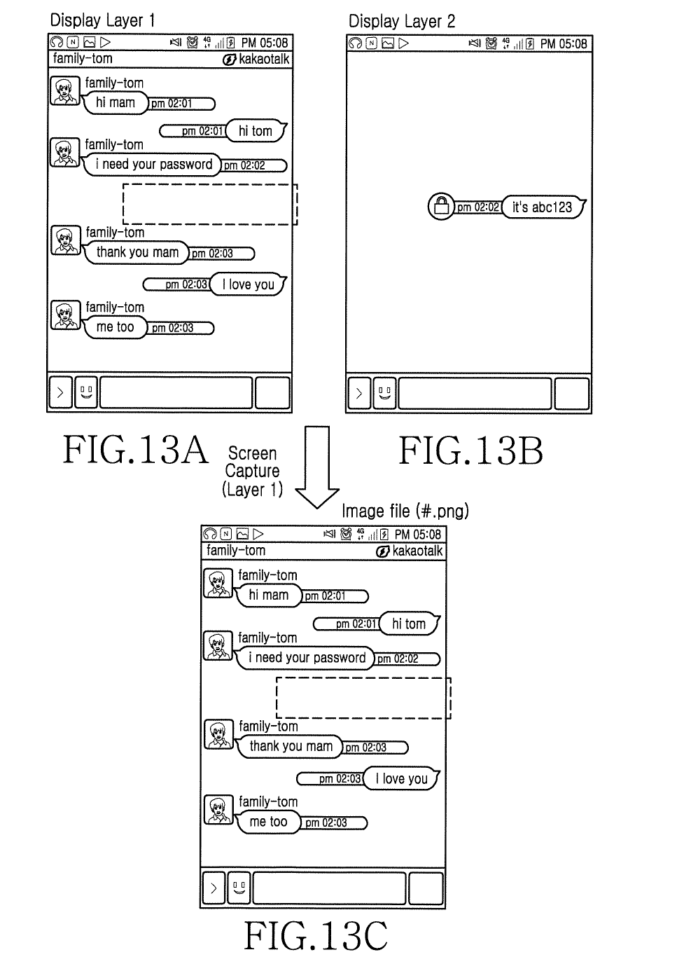

FIGS. 13A and 13B are diagrams illustrating a process of storing a messenger screen in which a security message is deleted into an image file according to various exemplary embodiments of the present disclosure. For example, as shown in FIGS. 13A and 13B, if a message transmitted and received through the 1:1 online chatting is a general message, the processor 210 controls to display the general message in a display layer 1 (S123), and if a message transmitted and received through the 1:1 online chatting is a security message in which a security code is set, the processor 210 controls to display the security message in a display layer 2 (S122). The security message can be displayed in a display layer different from the display layers 1 and 2.

The processor 210 controls to overlapping display a display layer 1 in which the general message is displayed and a display layer 2 in which the security message is displayed (S124), and the processor 210 determines whether a screen capture operation is requested by a user.

That is, the general message and the security message are individually displayed on different display layers, and a display layer of the general message and a display layer of the security message are overlapping displayed and thus a user recognizes that the general message and the security message are sequentially displayed within the messenger screen.

For example, when the user simultaneously pushes a power button and a home button or when the user performs a preset random specific operation for a screen capture request, the processor 210 of the electronic device receives a screen capture request corresponding thereto.

The processor 210 determines whether a request for screen capture is received (S125), and if a request for screen capture is received, the processor 210 screen captures a display layer 1 displayed on the messenger screen (S126), stores an image of the screen captured display layer 1 into an image file (S127), and performs operation in which the user requests (S128). Accordingly, as described with reference to FIG. 13C, because contents of a security message such as personal information are not included in an image file stored by a screen capture operation, the contents of the security message can be prevented from being exposed to another party.

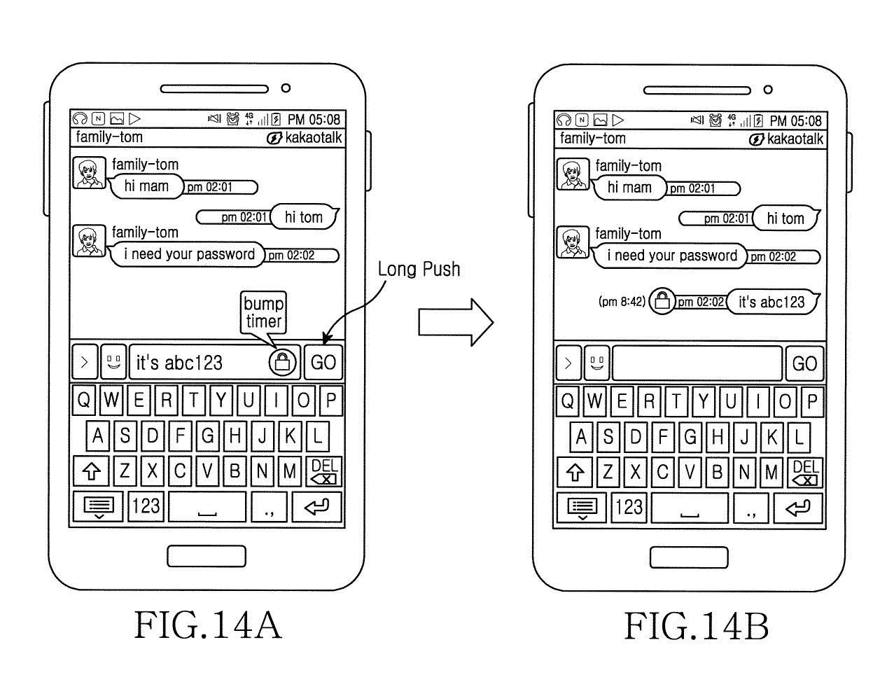

FIGS. 14A and 14B are diagrams illustrating a process of inputting a security message according to various exemplary embodiments of the present disclosure. For example, when the user long pushes a message transmitting button (e.g., GO of FIGS. 14A and 14B) while writing a random message through the messenger screen, the processor 210 of the electronic device controls to display a user interface (UI) screen that can set the security message.

On the user interface screen, various menu items that can select a date, a time, and a type of a security code can be displayed. For example, as an indicator for representing a type of a security code, an emoticon having at least one shape of, for example, a lock, a bomb, an hourglass, and a timer can be displayed.

The processor 210 can display a security indicator having a random shape in which the user selects together with a corresponding message. Further, when transmitting the message, the processor 210 transmits an intrinsic security code value for designating a display time limitation, a display number limitation, and a screen capture limitation together with the message. For example, as shown in FIGS. 14A and 14B, when a predetermined time (e.g., PM 8:40) arrives, a bomb (e.g., bomb timer) shaped-indicator that designates to automatically delete a corresponding message can be displayed together with a corresponding message. Accordingly, the user can easily set several kinds of security messages through a user interface screen.

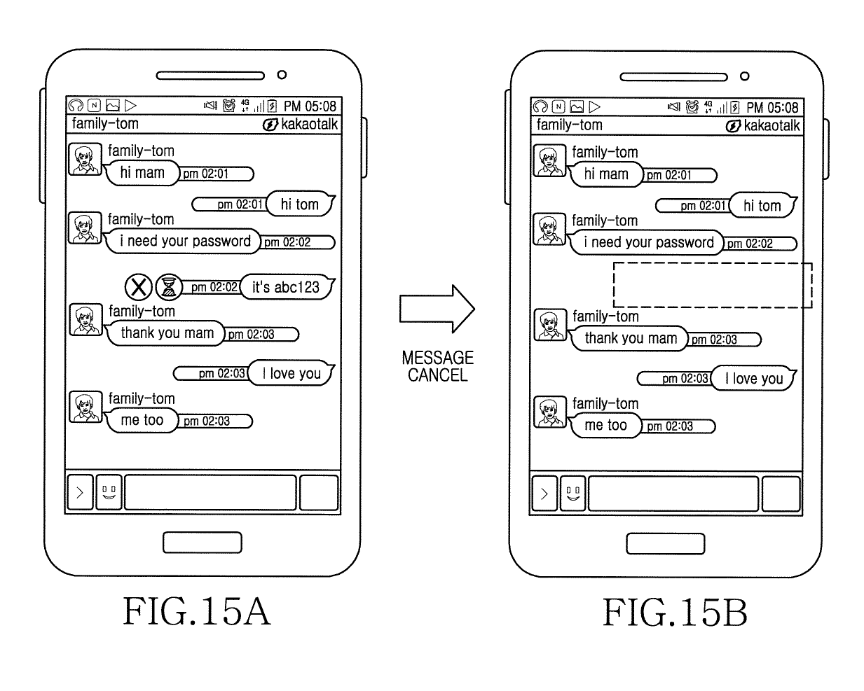

FIGS. 15A and 15B are diagrams illustrating a process of cancelling an already transmitted message according to various exemplary embodiments of the present disclosure. For example, the security message can be displayed together with a security indicator for representing at least one of a display time limitation, a display number limitation, and a screen capture limitation.

The processor 210 can cancel, for example, an already transmitted security message. For this, the processor 210 generates a request message that requests cancellation of the security message and transmits the request message to a messenger server (not shown). The request message includes a command that requests cancellation of the security message and information for selecting the security message, and the information can include, for example, user identification information (user id) that transmits a corresponding message, a date, a time, message contents, and a security code value.

For example, as shown in FIGS. 15A to 15B, when the user long pushes an emoticon of an hourglass displayed together with a security message within the messenger screen or when the user long pushes a speech bubble of a security message, the processor 210 controls to display an X-shaped emoticon as an indicator for representing cancellation of the security message. Thereafter, when the user pushes the X-shaped emoticon, the processor 210 determines that cancellation of the security message has been requested, generates a request message that requests cancellation of the security message, and transmits the request message to the messenger server.

The messenger server determines, for example, user identification information (user id), a date, a time, message contents, and a security code value included in the request message, searches for the message management information database described with reference to FIG. 8, and compares the data with data of the message management information database, and performs operation of selecting and cancelling a corresponding security message. Accordingly, as shown in FIG. 15, because a security message in which the user requests to cancel disappears on the messenger screen, important personal information can be prevented from being erroneously transmitted or from being displayed on the messenger screen for a long time.

According to various exemplary embodiments of the present disclosure, when screen capturing a messenger screen, after deleting or changing a security message so that the security message displayed within the messenger screen is not displayed, by storing the edited security message into an image file, important personal information of a user can be prevented from being exposed to another party. According to various exemplary embodiments of the present disclosure, because the user can easily set several kinds of security messages and can cancel an already transmitted message, user convenience can be enhanced.

Methods according to exemplary embodiments described in a specification or claims of various exemplary embodiments of the present disclosure can be implemented in a form of hardware, software, or a combination of hardware and software. When implemented with software, a computer readable storage medium that stores at least one program (software module) can be provided. At least one program stored at a computer readable storage medium is configured for execution by at least one processor within an electronic device.

At least one program includes instructions that enable an electronic device to execute methods according to exemplary embodiments described in a specification or claims of various exemplary embodiments of the present disclosure. Such a program (software module, software) can be stored at a Random Access Memory (RAM), a non-volatile memory including a flash memory, a Read-Only Memory (ROM), an Electrically Erasable and Programmable ROM (EEPROM), a magnetic disk storage device, a Compact Disk ROM (CD-ROM), a Digital Versatile Disk (DVD), or an optical storage device of other form, and a magnetic cassette.

Alternatively, the program can be stored at a memory formed with a combination of a portion or the entire thereof. Further, each constituent memory can be included in plural. Further, the program can be stored at an attachable storage device that can access through a communication network such as Internet, Intranet, a LAN, a Wireless LAN (WLAN), or a Storage Area Network (SAN) or a communication network formed with a combination thereof. Such a storage device can be connected to a device that performs an exemplary embodiment of the present disclosure through an external port. Further, a separate storage device on a communication network can be connected to a device that performs an exemplary embodiment of the present disclosure.

In specific exemplary embodiments of various exemplary embodiments of the present disclosure, a constituent element included in the disclosure is represented with the singular or the plural according to a suggested specific exemplary embodiment. However, an expression of the singular or the plural is selected appropriate to a situation suggested for convenience of description, and various exemplary embodiments of the present disclosure are not limited to a constituent element of the singular or the plural, and constituent elements represented with the plural can be formed in the singular or a constituent element represented with the singular can be formed in the plural.

While the present disclosure has been particularly shown and described with reference to exemplary embodiments thereof, it will be understood by those skilled in the art that various changes in form and details can be made therein without departing from the spirit and scope of the present disclosure as defined by the appended claims.

What is claimed is:

1. A method of operating an electronic device, the method comprising:
receiving a screen capture request while displaying a messenger screen;
selecting a security message from a plurality of messages displayed on the messenger screen; and
editing out the security message and storing the security message into an image file.

2. The method of claim 1, wherein storing the security message comprises changing or deleting the security message so that contents of the security message are not displayed and storing the security message into an image file.

3. The method of claim 1, wherein selecting the security message comprises searching for message management information corresponding to the plurality of messages and selecting a message in which a security code is set as a security message.

4. The method of claim 3, wherein the message management information comprises at least one of message contents, user identification information, date and time information, and a security code.

5. The method of claim 3, wherein storing the security message comprises reconfiguring a messenger screen by editing out the security message, screen capturing the messenger screen, and storing the messenger screen into an image file.

6. The method of claim 1, wherein selecting the security message comprises screen capturing the messenger screen, temporarily storing the messenger screen into an image, scanning the image, and selecting a message displayed together with a security indicator as a security message.

7. The method of claim 6, wherein storing the security message comprises editing a security message included within the temporarily stored image and storing the security message into an image file.

8. The method of claim 1, wherein the security message is displayed together with a security indicator for representing at least one of a display time limitation, a display number limitation, and a screen capture limitation.

9. The method of claim 8, wherein the security indicator is displayed in a shape of at least one of a lock, a bomb, an hourglass, and a timer and is randomly selected by a user interface.

10. The method of claim 1, further comprising transmitting a request message for cancelling the security message to a messenger server,
wherein the request message comprises a command that requests cancellation of the security message and information for selecting the security message.

11. An electronic device, comprising:
a display configured to display a messenger screen;
a memory configured to store an image file; and
a processor configured to:
upon a request for capturing a screen, capture the messenger screen;
select a security message from a plurality of messages displayed on the messenger screen,
edit out the security message on the messenger screen; and
store the security message in the image file.

12. The electronic device of claim 11, wherein the processor is further configured to:
change or delete the security message so that contents of the security message are not displayed; and
store the security message into the image file.

13. The electronic device of claim 11, wherein the processor is further configured to:
search for message management information corresponding to the plurality of messages; and
select a message that is set as a security message.

14. The electronic device of claim 13, wherein the message management information comprises at least one of message contents, user identification information, date and time information, and a security code.

15. The electronic device of claim 13, wherein the processor is further configured to reconfigure a messenger screen by editing out the security message, screen captures the messenger screen, and stores the messenger screen into an image file.

16. The electronic device of claim 11, wherein the processor is further configured to:
capture the messenger screen;
temporarily store the messenger screen into an image;
scan the image; and
select a message displayed together with a security indicator as a security message.

17. The electronic device of claim 16, wherein the processor is further configured to:
edit a security message included within the temporarily stored image; and
store the security message into an image file.

18. The electronic device of claim 11, wherein the security message is displayed together with a security indicator for representing at least one of a display time limitation, a display number limitation, and a screen capture limitation, and
the security indicator is displayed in a shape of at least one of a lock, a bomb, a hourglass, and a timer and is randomly selected by a user interface.

19. The electronic device of claim 11, wherein the processor is further configured to transmit a request message for cancelling the security message to a messenger server, and the request message comprises a command that requests cancellation of the security message and information for selecting the security message.

20. A computer readable recoding medium on which a computer program for executing a method is recoded, the method comprising:
receiving a screen capture request while displaying a messenger screen;
selecting a security message from a plurality of messages displayed on the messenger screen; and
editing out the security message and storing the security message into an image file
